(19) United States
(12) Patent Application Publication
(10) Pub. No.: US 2011/0131073 A1
(43) Pub. Date: Jun. 2, 2011

(54) METHOD AND SYSTEM FOR MANAGING SPECIAL AND PARATRANSIT TRIPS

(75) Inventors: Anthony B. GALE, Hutto, TX (US); Mary Ann FERRIS-YOUNG, Walker, MI (US); Derek E. AMERLINCK, East Amherst, NY (US)

(73) Assignee: ECOLOGY & ENVIRONMENT, INC., Lancaster, NY (US)

(21) Appl. No.: 12/627,329

(22) Filed: Nov. 30, 2009

(51) Int. Cl. G06Q 10/00

(52) U.S. Cl. 705/5; 705/7.12

(57) ABSTRACT

A computer based method for managing special needs transportation, including receiving, using a processor for at least one specially programmed computer, data from a plurality of agencies having at least one vehicle available for providing transportation for clients with special needs. The data includes manifests for the at least one vehicle. The method uses the processor to: receive a request for transportation for a client; generate a visual representation of how the request affects the scheduling and capacity for agency vehicles; enable access by the agencies to the data, the request, and the visual representations; receive an offer from a respective computer system for an agency from the plurality of agencies to provide a vehicle to provide the transportation requested in the request; modify the data to incorporate changes to the data for the agency due to providing the vehicle; and transmit information regarding the request to the vehicle.

### FIELD OF THE INVENTION

The present invention relates generally to a system and method to coordinate services among agencies providing transportation for clients with special needs.

### BACKGROUND OF THE INVENTION

The prior art teaches persons with special needs transportation requirements contacting various agencies to satisfy those requirements.

### BRIEF SUMMARY OF THE INVENTION

The present invention broadly comprises a computer based method for managing special needs transportation, including: receiving, using a first processor for at least one first specially programmed computer, data from a plurality of agencies, each agency having at least one vehicle available for providing transportation for clients with special needs related to physical or mental impairment of the clients, the data includes respective manifests, for the plurality of agencies, with scheduling for the at least one vehicle and seating in the at least one vehicle; receiving, using the first processor, a first request for transportation for a first client, the first request including a first pick up location, a first pick up time, and a first destination; generating, using the first processor, a respective visual representation of how the first request affects the scheduling for and seating in the at least one vehicle for said each agency; enabling, using the first processor, access by respective computer systems for the plurality of agencies to the data, to the first request, and to the respective visual representations; receiving, using the first processor, an offer, from a respective computer system for an agency from the plurality of agencies, to provide a first vehicle to provide the transportation requested in the first request; modifying, using the first processor, the data to incorporate change to the data for the agency due to providing the first vehicle; and transmitting, using the first processor, information regarding the first request to the first vehicle.

The present invention also broadly comprises a computer based system for managing special needs transportation, including a first processor for at least one first specially programmed computer for: receiving data from a plurality of agencies, each agency having at least one vehicle available for providing transportation for clients with special needs related to physical or mental impairment of the clients, the data includes respective manifests, for the plurality of agencies, with scheduling for the at least one vehicle and seating in the at least one vehicle; receiving a first request for transportation for a first client, the first request including a first pick up location, a first pick up time, and a first destination; generating a respective visual representation of how the first request affects the scheduling for and seating in the at least one vehicle for said each agency; enabling access by respective computer systems for the plurality of agencies to the data, to the first request, and to the respective visual representations; receiving an offer, from a respective computer system for an agency from the plurality of agencies, to provide a first vehicle to provide the transportation requested in the first request; modifying the data to incorporate change to the data for the agency due to providing the first vehicle; and transmitting information regarding the first request to the first vehicle. The system also includes a memory device for the at least one first specially programmed computer for storing the data and the modified data.

A general object of the present invention is to provide a system and method to coordinate services among agencies providing transportation for clients with special needs.

This and other objects, features and advantages of the present invention will become readily apparent to those having ordinary skill in the art from a reading and study of the following detailed description of the invention, in view of the drawing and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a computer based system for managing special needs transportation; and,

FIGS. 2 through 7 are photographs of screens illustrating operation of the system shown in FIG. 1.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

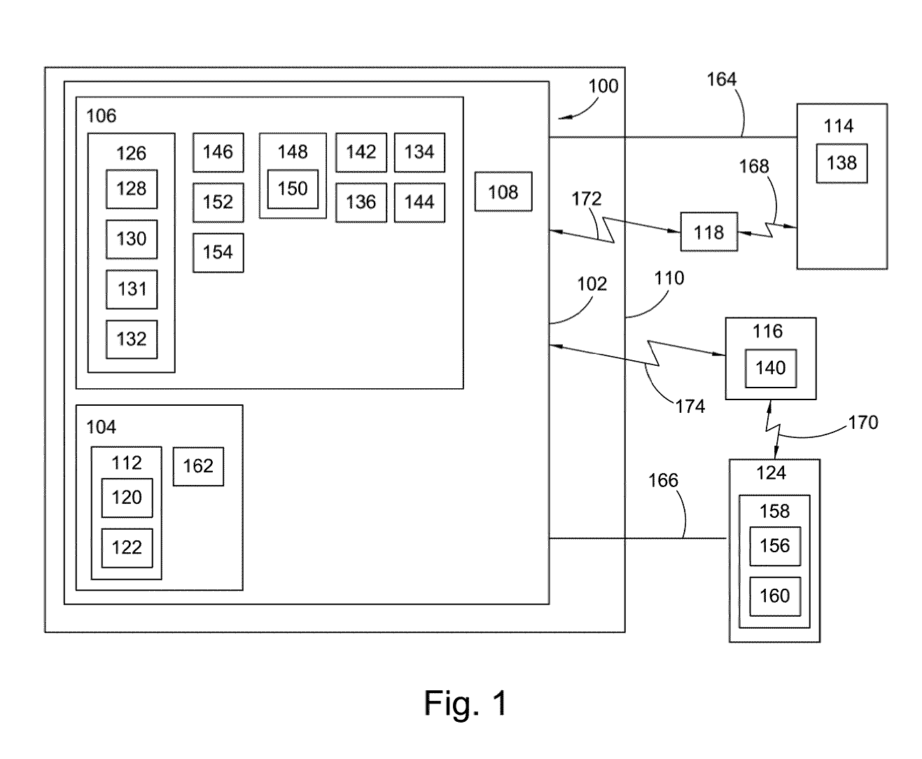

FIG. 1 is a schematic block diagram of computer based system 100 for managing special needs transportation. The system includes at least one specially-programmed general purpose computer, for example, computer 102, with memory element 104, processor 106, and interface element 108. By interface element, we mean any combination of hardware, firmware, or software in a computer used to enable communication or data transfer between the computer and a device, system, or network external to the computer. The interface element can connect with the device, system, or network external to the computer using any means known in the art, including, but not limited to a hardwire connection, an optical connection, an Internet connection, or a radio frequency connection. Processor 106 and interface element 108 can be any processor or interface element, respectively, or combination thereof, known in the art. In one embodiment, some or all of the transmissions to and from computer 100 are via the interface element.

Computer 102 can be any computer or plurality of computers known in the art. In one embodiment, the computer is located in single location with which system 100 is associated, for example, location 110. In another embodiment (not shown), all or parts of the computer are remote from a location with which system 100 is associated.

Processor 102 is for receiving data 112 from a plurality of agencies, for example, agencies 114 and 116. Each agency has at least one vehicle, for example, vehicle 118 associated with agency 114, available for providing transportation for clients (not shown) with special needs related to physical or mental impairment of the clients. The data includes respective manifests for vehicles associated with the plurality of agencies, for example, manifests 120 and 122, for vehicle 118 and vehicle 124, associated with agency 116, respectively. The manifests include information regarding scheduling, seating capacity, and available seating in the respective vehicles. In one embodiment, the data is stored in device 104.

Processor 102 also receives a request 126 for transportation for a client (not shown), the request including pick up location 128, pick up time 130, and destination 131. In one embodiment, the request includes return time 132. The processor generates respective visual representations for each vehicle in the plurality of vehicles, for example, representations 134 and 136 for vehicles 118 and 124, respectively, of how request 126 would affect the scheduling for each vehicle and the seating in each vehicle if the agencies should accept the request and fulfill the request using vehicles associated with the agencies. For example, representation 134 shows changes to the schedule and seating for vehicle 118, if vehicle 118 is used to satisfy request 126. In one embodiment, the request is transmitted by processor 106 to agencies interfaced with system 100. In one embodiment, the visual representations are transmitted to the respective agencies by the processor.

Processor 102 also is for enabling access by respective computer systems for the plurality of agencies, for example, systems 138 and 140 for agencies 114 and 116, respectively, to system 100. The access enables the agency computers to view data 112, requests, for example, request 126, and visual representations, for example, representations 134 and 136.

Processor 102 receives offer 142, from a respective computer system for one of the agencies, for example, computer 138, to provide a vehicle, for example, vehicle 118, to provide the transportation requested in request 126. The processor modifies data 112 to incorporate changes to the data for the agency providing the offer. The changes are related to providing the vehicle, for example, vehicle 118. For example, manifest 120 is updated to incorporate changes to scheduling and seating for vehicle 118 due to fulfilling request 126. The processor transmits information 144 regarding request 126 to the vehicle fulfilling request 126, for example, vehicle 118. The information includes instructions for the driver of the vehicle, such as where and when to pick up the client and where to take the client.

In one embodiment, processor 106 is for receiving instructions 146 from a respective computer system, for example, system 138, from the plurality of agencies, to remove a client (not shown) from a manifest, for example, manifest 120. For example, the client is scheduled for transportation using the vehicle that is to fulfill request 126, for example, vehicle 118. That is, to accommodate request 126 a previously scheduled passenger for vehicle 118 is “bumped” to make room. In one embodiment, to ensure that the transportation requirements of the “bumped” passenger are met, system 100 generates request 148 for transportation of the “bumped” client. Request 148 includes data 150 including pick up time and place and destination for the “bumped” client. System 100 transmits request 148 to the computer systems for the plurality of agencies so that the agencies can determine how to provide for the “bumped” client.

In one embodiment, the processor receives request 152 for transportation for a client (not shown), including a destination, a pick up time, and an open-ended return time. For example, the destination could be a doctor's office and the client cannot predict when an appointment with the doctor will be finished. Hence, the client cannot predict a time for pick up from the doctor's office. That is, the request is a “will call” request. For example, the client will contact the appropriate agency when the doctor's visit is completed. The processor is for transmitting request 152 to computer systems for the plurality of agencies so that the agencies can provide for the client's transportation requirements.

In one embodiment, manifests include information regarding special needs for persons scheduled for transportation using the respective vehicle. In one embodiment, data 112 includes information regarding physical structures or configurations of the vehicles associated with the agencies, suitable for accommodating special needs related to physical or mental impairment of the passengers. If request 126 includes information regarding a physical or mental impairment of a client, the processor identifies vehicles having the appropriate structure or configuration, generates alert 154 including the identifications, and transmits the alert to the agencies.

In one embodiment, system 10 includes processors, for example, processor 156, for specially programmed computers, for example, computer 158, in vehicles associated with the plurality of agencies, for example, vehicle 124. The processors in the vehicles are for displaying a safety check list including a plurality of prompts, for example, on a graphical user interface (GUI), for example, GUI 160, for the computer, and receiving inputs responsive to the plurality of prompts, for example, via a GUI such as GUI 160. The inputs include an identification of the driver of the vehicle. The processors in the vehicles, for example, processor 156, transmit the inputs to system 100, and processor 102 receives the inputs from the processors in the vehicles. Processor 102 compiles a history, for example, history 162, for a respective driver, and stores the histories in device 104. The histories can be accessed by the agencies interfacing with system 100 and can be used to assess driver compliance.

Connections, for example, connections 164 and 166, between agencies, for example, agency 114 and 116, respectively, and system 100 can be any type known in the art. Connections, for example, connections 168 and 170, between agencies, for example, agency 114 and 116, respectively, and vehicles, for example, vehicles 118 and 124, respectively, can be any type known in the art. Connections, for example, connections 172 and 174, between vehicles, for example, vehicles 118 and 124, respectively, and system 100 can be any type known in the art.

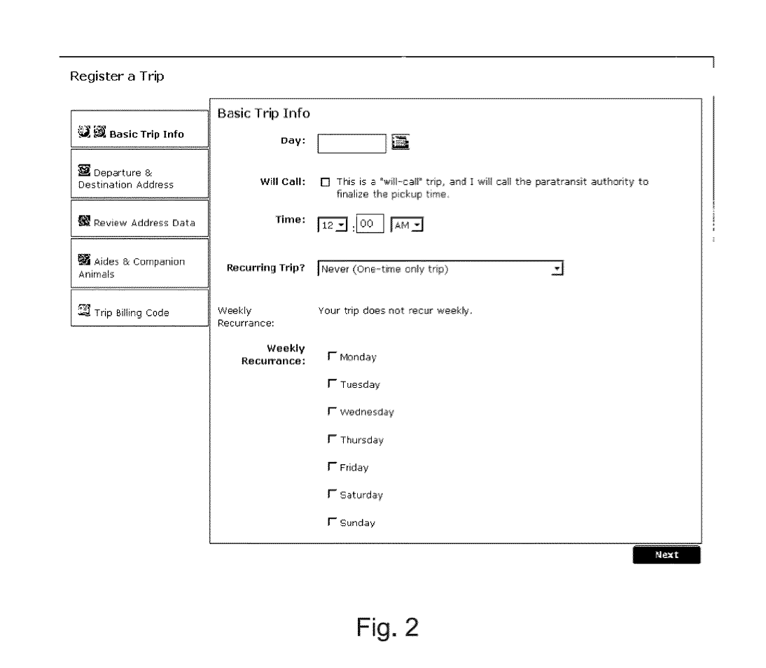

FIG. 2 is a photograph of a screen for a computer, for example, computer 138, for an agency, for example, agency 114, interfacing with system 100, for example, generating and transmitting to system 100, requests for transportation, such as request 126. Using the pull down menus and check boxes shown in FIG. 2, information regarding a request for transportation is entered. By selecting “Next,” the information entered in FIG. 2 is transmitted to system 100.

As requests for transportation are scheduled, for example, by clients or client-aides through the agencies noted above, the requests are transmitted to system 100, which can be considered a clearinghouse system. System 100 allows all available transportation options, for example, through access to manifests in data 112, from all agencies to be viewed in one location, that is, in system 100. Dispatchers for the various agencies interfacing with system 100 have the ability to choose to accept requests and to “bump” previously scheduled passengers if necessary or desirable. Changes to manifests are automatically made in system 100 and transmitted to computers in the vehicles, for example, computer 158 in vehicle 124. Thus system 100 operates in real time to quickly respond to transportation requests and to keep all parties involved up to date.

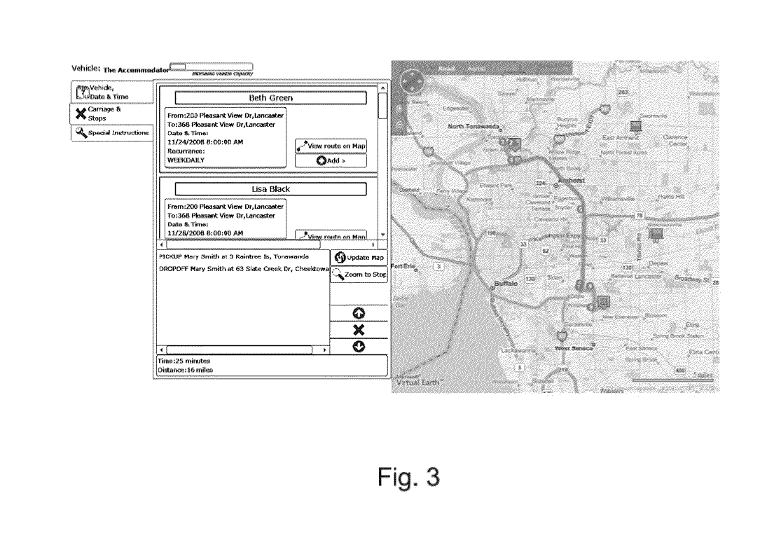

FIG. 3 is a photograph of a screen for a computer, for example, computer 138, for an agency interfacing with system 100. System 100 generates and makes available to agencies interfacing with the system, map interfaces, for example, representations 134 and 136. FIG. 3 shows an example of such an interface or representation. The interface or representation can be accessed and viewed by dispatchers for the agencies, providing a visual representation of how a request, such as request 126, will impact schedules, capacity, and accommodation for vehicles for the agencies. This visual display enables dispatchers to make quick and accurate decisions as to whether to accept or decline requests and enables dispatches to quickly and accurately assess on-going operations if a request is accepted. Further, the representations enable quick and accurate communication and decision making among agencies. For example, if FIG. 3, changes and considerations with respect to adding Beth Green to a scheduled trip for Lisa Black are shown.

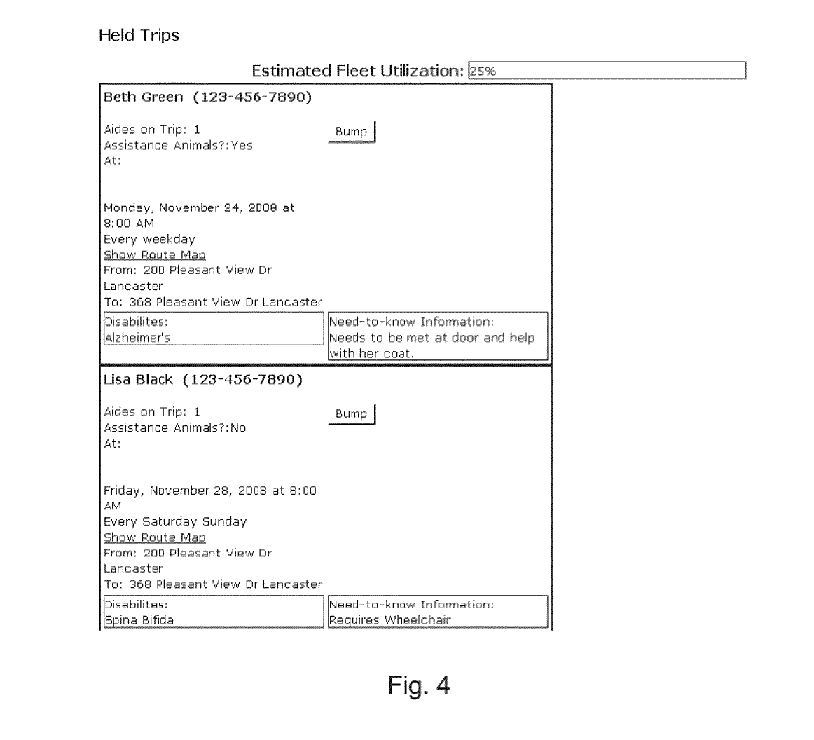

FIG. 4 is a photograph of a screen for a computer, for example, computer 138, for an agency, for example, agency 116, interfacing with system 100. When “bumps” occur, a message, for example, request 148, is transmitted to the agencies interfacing with system 100 to enable dispatchers for the agencies to reschedule the transportation request for the “bumped” passenger. FIG. 4 shows such a request. “Will call” clients are handled in a similar fashion. Will-call clients have a starting time but no ending time, for example a trip to a doctor's office where the end time could vary because the length of the appointment is unknown. Will-call clients are treated like “bumped” clients with notices, for example, request 148, sent out to all agencies interfacing with system 100. In an example, embodiment, system 100 flags “bumped” and “will call” clients as having a higher priority and this higher priority is factored into scheduling for these clients.

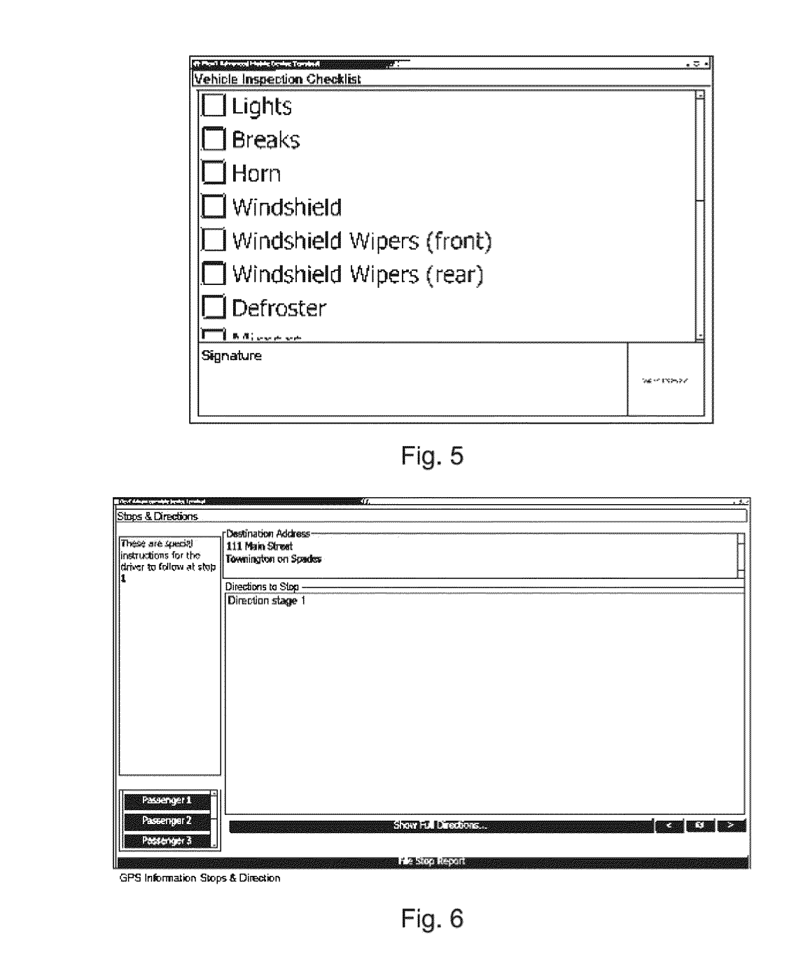

FIG. 5 is a photograph of a screen, for example, GUI 160, in a vehicle, for example, vehicle 124, for an agency, for example, agency 116, interfacing with system 100. Drivers check into vehicles, such as vehicle 124, using an on-board computer, such as computer 158 and a confidential login code. In one embodiment, the first screen displayed on the GUI for the computer is an automated vehicle safety checklist, as shown in FIG. 5. In one embodiment, the checklist can be customized by the agency associated with the vehicle to fit specific needs. Driver responses, that is, inputs to prompts/boxes in the checklist are transmitted to system 100. In one embodiment, the safety checklist must be completed before a driver starts a trip, promoting safety and driver compliance.

FIG. 6 is a photograph of a screen, for example, GUI 160, in a vehicle, for example, vehicle 124, for an agency, for example, agency 116, interfacing with system 100. In one embodiment, drivers for vehicles interfacing with system 100, for example, vehicle 124, receive daily schedules and verify pick-ups and drop-offs on a touch screen for the on-board computer, for example computer 158. Such a screen is shown in FIG. 6. In one embodiment, an interface with system 100 includes a global positioning system (GPS) to identify the location of the vehicle. The location can be viewed in near real-time in differing map formats by dispatchers or other personnel associated with the appropriate agency.

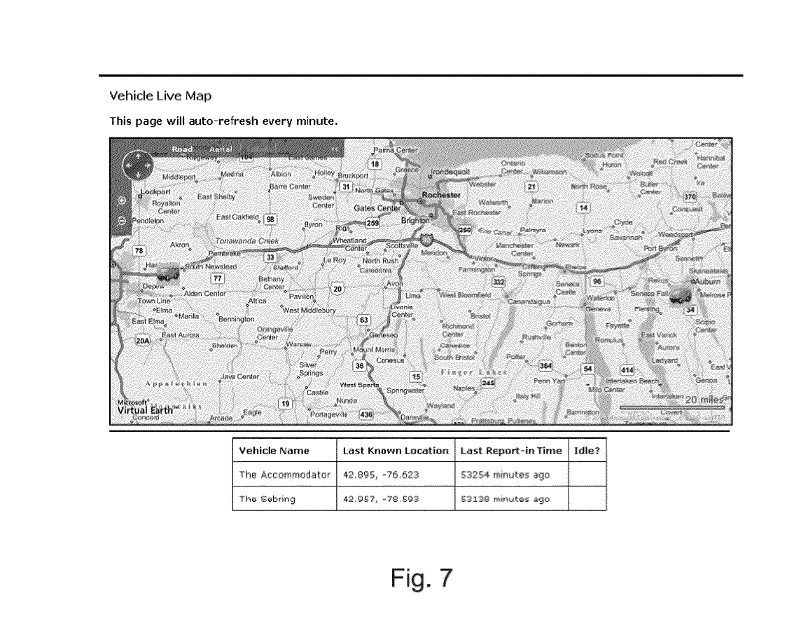

FIG. 7 is a photograph of a screen for a computer, for example, computer 138, for an agency, for example, agency 116, interfacing with system 100. In one embodiment, system 100 provides real time mapping and locating for vehicles interfacing with the system. An example, of this mapping and locating is shown in FIG. 7. Real-time location is valuable in assisting drivers in locating hard to find locations, such as client driveways, because the dispatcher can now “see” the location of the vehicle and the client and direct drivers accordingly. In one embodiment, prior to each run, the driver must login to the vehicle on-board computer. Logging in prior to each run helps to keep client information confidential, with data less at risk of being compromised. On-board computer have internal cell cards, which are vendor defined by client, so the coverage area is best suited for each location. If there is a temporary drop in cell service, system 100 stores all of the data until service is restored. on-board computer, if a vehicle is stopped for more than a specified period of time, for example, 15 minutes, this information is communicated to the dispatcher, so action can be taken as needed.

System 100 can be considered a clearinghouse bringing together a plethora of agencies providing special needs transportation with clients having special needs transportation requirements. As rides are scheduled by clients or client-aides they are placed in system 100. The system allows all available rides from all agencies to be viewed in one location. Agency dispatchers have the ability to choose to accept rides or “bump” rides from their manifests. Changes to manifests are automatically loaded into in-vehicle computer systems. System 100 provides a map interface for dispatchers, providing a visual representation of how a transportation request will impact schedules, as well as how the transportation request will effect capacity and accommodation requirements. The dispatcher can then choose to add a client or leave the transportation request in the list for another agency to choose. If there is a situation when a vehicle cannot provide the rides already committed to its schedule, the dispatcher can “bump” the rides back to system 100. When “bumps” occur, a message is sent to all dispatches in order to allow the agencies to try to reschedule the trip to accommodate the bumper client. A similar system is used for will-call rides. Will-call rides have a starting time but no ending time, for example a trip to a doctor's office where the end time could vary because the length of the appointment is unknown. Will-call rides are treated like “bumped” rides with notices sent out to all dispatchers at all agencies.

System 100 provides an easy to use client and management interface for the consolidation of specialized and paratransit trips. System 100 includes a user friendly Web interface, intelligent voice recognition (IVR), FTA and ADA compliance, and 5310 and grant specific reporting. For example, system 100 provides:
Simple Web-Based Client Registration
Easy Web-Based Account Creation
Three Ways To Check Account Status
Easy Web-Based Trip Scheduling for Clients
Easy Web-Based Trip Scheduling For Agencies
Real-Time Interface of Vehicles/Drivers and Administrators
Near Real-Time Vehicle Locator Mapping And Status

To create an account the client provides their name and contact information. In one embodiment, each account has an independent identification number assigned to it. This number can be any identification number known in the art, for example, a social security number, or a number assigned by an agency. In one embodiment, the format for the identification number has the same format for each agency, e.g. xxx-xx-xxxx. In one embodiment, new clients also provide information on disabilities, home address, emergency contacts, medical information, and billing codes. Tracking information electronically increases the safety and privacy of client data through the use of secure IT layers. Additionally, the improved speed of accessing data is important in case of an emergency.

In one embodiment, once registered, clients have the option to check on the status of their application through multiple channels, including a Web interface or a toll-free number with intelligent voice recognition (IVR) system. To use the IVR system, clients call a pre-assigned toll-free number, enter their account number into the telephone key pad and receive updates via the telephone on the status of their account. IVR provides increased accessibility to users without Internet access but does not require additional staff resources because it is computer-based, saving the agencies money.

According to aspects illustrated herein, there is provided a method for managing special needs transportation, including: receiving, using a first processor for at least one first specially programmed computer, data from a plurality of agencies, each agency having at least one vehicle available for providing transportation for clients with special needs related to physical or mental impairment of the clients, the data includes respective manifests, for the plurality of agencies, with scheduling for the at least one vehicle and seating in the at least one vehicle; receiving, using the first processor, a first request for transportation for a first client, the first request including a first pick up location, a first pick up time, and a first destination; generating, using the first processor, a respective visual representation of how the first request affects the scheduling for and seating in the at least one vehicle for said each agency; enabling, using the first processor, access by respective computer systems for the plurality of agencies to the data, to the first request, and to the respective visual representations; receiving, using the first processor, an offer, from a respective computer system for an agency from the plurality of agencies, to provide a first vehicle to provide the transportation requested in the first request; modifying, using the first processor, the data to incorporate change to the data for the agency due to providing the first vehicle; and transmitting, using the first processor, information regarding the first request to the first vehicle.

In one embodiment, the method includes: receiving, using the first processor, instructions, from the respective computer system, to remove a second client, scheduled for transportation using the first vehicle, from a manifest for the first vehicle; generating, using the first processor, a second request for transportation for the second client, the second request including a second destination and a second pick up time; and transmitting, using the first processor, the second request for transportation to the respective computer systems for the plurality of agencies. In one embodiment, the method includes: receiving, using the first processor, a second request for transportation for a client, the second request including a second destination, a second pick up time, and an open-ended return time; and transmitting, using the first processor, the second request for transportation to the respective computer systems for the plurality of agencies.

In one embodiment, the respective manifests include information regarding persons scheduled for transportation using the at least one vehicle, any special needs for the persons, pick up times for the persons, and destinations for the persons; modifying the data includes modifying a manifest for the first vehicle; and transmitting information regarding the request for transportation to the first vehicle includes transmitting the modified manifest to the first vehicle. In one embodiment, the data includes information regarding physical structures or configurations of the at least one vehicle suitable for accommodating the special needs related to physical or mental impairment of the clients; the first request includes information regarding a physical or mental impairment of the first client, the method further comprising identifying, using the first processor, vehicles having structure or configuration appropriate for the physical or mental impairment of the first client. In one embodiment, the method includes: displaying, using a second processor for at least one second specially programmed computer in a second vehicle from the at least one vehicle, a safety check list including a plurality of prompts; receiving, using the second processor, input responsive to the plurality of prompts, the input including identification of a driver of the second vehicle; receiving, using the first processor, the input from the second processor; and compiling, using the first processor, a history, for the driver, of inputs from the second processor.

It should be understood that a present invention device is not limited to the configuration shown in the figures. For example, different numbers and configurations of components can be used to obtain the claimed invention.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A computer based method for managing special needs transportation, comprising:
receiving, using a first processor for at least one first specially programmed computer, data from a plurality of agencies, each agency having at least one vehicle available for providing transportation for clients with special needs related to physical or mental impairment of the clients, the data includes respective manifests, for the plurality of agencies, with scheduling for the at least one vehicle and seating in the at least one vehicle;
receiving, using the first processor, a first request for transportation for a first client, the first request including a first pick up location, a first pick up time, and a first destination;
generating, using the first processor, a respective visual representation of how the first request affects the scheduling for and seating in the at least one vehicle for said each agency;
enabling, using the first processor, access by respective computer systems for the plurality of agencies to the data, to the first request, and to the respective visual representations;
receiving, using the first processor, an offer, from a respective computer system for an agency from the plurality of agencies, to provide a first vehicle to provide the transportation requested in the first request;
modifying, using the first processor, the data to incorporate change to the data for the agency due to providing the first vehicle; and,
transmitting, using the first processor, information regarding the first request to the first vehicle.

2. The method of claim 1 further comprising:
receiving, using the first processor, instructions, from the respective computer system, to remove a second client, scheduled for transportation using the first vehicle, from a manifest for the first vehicle;
generating, using the first processor, a second request for transportation for the second client, the second request including a second destination and a second pick up time; and,
transmitting, using the first processor, the second request for transportation to the respective computer systems for the plurality of agencies.

3. The method of claim 1 further comprising:
receiving, using the first processor, a second request for transportation for a client, the second request including a second destination, a second pick up time, and an open-ended return time; and,
transmitting, using the first processor, the second request for transportation to the respective computer systems for the plurality of agencies.

4. The method of claim 1 wherein:
the respective manifests include information regarding persons scheduled for transportation using the at least one vehicle, any special needs for the persons, pick up times for the persons, and destinations for the persons;
modifying the data includes modifying a manifest for the first vehicle; and,
transmitting information regarding the request for transportation to the first vehicle includes transmitting the modified manifest to the first vehicle.

5. The method of claim 1 wherein:
the data includes information regarding physical structures or configurations of the at least one vehicle suitable for accommodating the special needs related to physical or mental impairment of the clients;
the first request includes information regarding a physical or mental impairment of the first client, the method further comprising identifying, using the first processor, vehicles having structure or configuration appropriate for the physical or mental impairment of the first client.

6. The method of claim 1 further comprising:
displaying, using a second processor for at least one second specially programmed computer in a second vehicle from the at least one vehicle, a safety check list including a plurality of prompts;
receiving, using the second processor, input responsive to the plurality of prompts, the input including identification of a driver of the second vehicle;
receiving, using the first processor, the input from the second processor; and,
compiling, using the first processor, a history, for the driver, of inputs from the second processor.

7. A computer based system for managing special needs transportation, comprising:
a first processor for at least one first specially programmed computer for:
receiving data from a plurality of agencies, each agency having at least one vehicle available for providing transportation for clients with special needs related to physical or mental impairment of the clients, the data includes respective manifests, for the plurality of agencies, with scheduling for the at least one vehicle and seating in the at least one vehicle;
receiving a first request for transportation for a first client, the first request including a first pick up location, a first pick up time, and a first destination;
generating a respective visual representation of how the first request affects the scheduling for and seating in the at least one vehicle for said each agency;
enabling access by respective computer systems for the plurality of agencies to the data, to the first request, and to the respective visual representations;
receiving an offer, from a respective computer system for an agency from the plurality of agencies, to provide a first vehicle to provide the transportation requested in the first request;
modifying the data to incorporate change to the data for the agency due to providing the first vehicle; and,
transmitting information regarding the first request to the first vehicle; and,
a memory device for the at least one first specially programmed computer for:
storing the data and the modified data.

8. The system of claim 7 wherein the first processor is for:
receiving instructions, from the respective computer system, to remove a second client, scheduled for transportation using the first vehicle, from a manifest for the first vehicle;
generating a second request for transportation for the second client, the second request including a second destination and a second pick up time; and,
transmitting the second request for transportation to the respective computer systems for the plurality of agencies.

9. The system of claim 7 wherein the first processor is for:
receiving a second request for transportation for a client, the second request including a second destination, a second pick up time, and an open-ended return time; and,
transmitting the second request for transportation to the respective computer systems for the plurality of agencies.

10. The system of claim 7 wherein;
the respective manifests include information regarding persons scheduled for transportation using the at least one vehicle, any special needs for the persons, pick up times for the persons, and destinations for the persons;
modifying the data includes modifying a manifest for the first vehicle; and,
transmitting information regarding the request for transportation to the first vehicle includes transmitting the modified manifest to the first vehicle.

11. The system of claim 7 wherein:
the data includes physical structures or configurations of the at least one vehicle suitable for accommodating the special needs related to physical or mental impairment of the clients;
the first request includes information regarding a physical or mental impairment of the first client;
the first processor is for identifying vehicles having structure or configuration appropriate for the physical or mental impairment of the first client.

12. The system of claim 7 further comprising a second processor for at least one second specially programmed computer in a second vehicle from the at least one vehicle, for:
displaying a safety check list including a plurality of prompts; and,
receiving input responsive to the plurality of prompts, the input including identification of a driver of the second vehicle, wherein the first processor is for:
receiving the input from the second processor; and,
compiling a history, for the driver, of inputs from the second processor.

13. A computer based system for managing special needs transportation, comprising:
a processor for at least one specially programmed computer for:
receiving data from a plurality of agencies, each agency having at least one vehicle available for providing transportation for clients with special needs related to physical or mental impairment of the clients, the data includes respective manifests, for the plurality of agencies, with scheduling for the at least one vehicle and seating in the at least one vehicle;
receiving a first request for transportation for a first client, the first request including a first pick up location, a first pick up time, and a first destination;
generating a respective visual representation of how the first request affects the scheduling for and seating in the at least one vehicle for said each agency;
enabling access by respective computer systems for the plurality of agencies to the data, to the first request, and to the respective visual representations;
receiving a first offer, from a first respective computer system for a first agency from the plurality of agencies, to provide a first vehicle to provide the transportation requested in the first request;
receiving instructions, from the first respective computer system, to remove a second client, scheduled for transportation using the first vehicle, from a manifest for the first vehicle;
generating a second request for transportation for the second client, the second request including a second pick up location, a second pick up time, and a second destination;
transmitting the second request for transportation to the respective computer systems for the plurality of agencies;
receiving a second offer, from a second respective computer system for a second agency from the plurality of agencies, to provide a second vehicle to provide the transportation requested in the second request;
modifying the data to incorporate change to the data for the first and second agencies due to providing the first and second vehicles, respectively; and,
transmitting information regarding the first and second requests to the first and second vehicles, respectively; and,
a memory device for the at least one specially programmed computer for:
storing the data and the modified data.
